(19) United States
(12) Patent Application Publication
(10) Pub. No.: US 2014/0127551 A1
(43) Pub. Date: May 8, 2014

(54) RECHARGEABLE BATTERY AND MODULE OF THE SAME

(71) Applicants: ROBERT BOSCH GMBH, Stuttgart (DE); SAMSUNG SDI CO., LTD., Yongin-si (KR)

(72) Inventor: Duk-Jung KIM, Yongin-si (KR)

(73) Assignees: ROBERT BOSCH GMBH, Stuttgart (DE); SAMSUNG SDI CO., LTD., Yongin-si (KR)

(21) Appl. No.: 13/783,048

(22) Filed: Mar. 1, 2013

Related U.S. Application Data
(60) Provisional application No. 61/662,142, filed on Jun. 20, 2012.

(51) Int. Cl. H01M 2/04

(52) U.S. Cl. CPC H01M 2/0482; H01M 2/043; H01M 2/0404
USPC 429/156; 429/179

(57) ABSTRACT

A rechargeable battery and a battery module. A rechargeable battery includes: a unit cell including an electrode assembly, a case containing the electrode assembly, a cap plate covering an opening of the case, and a terminal electrically connected to the electrode assembly and protruding through the cap plate; and a cover including an electrically insulating material and covering the cap plate, the cover having an opening exposing the terminal therethrough.

### CROSS-REFERENCE TO RELATED APPLICATION

This application claims priority to and the benefit of U.S. Provisional Application No. 61/662,142, filed on Jun. 20, 2012 in the United States Patent & Trademark Office, the entire content of which is incorporated herein by reference.

### BACKGROUND

1. Field

Aspects of embodiments of the present invention relate to a rechargeable battery and a module thereof.

2. Description of the Related Art

Unlike a primary battery that is not rechargeable, a rechargeable battery may be repeatedly charged and discharged. A small-capacity rechargeable battery is typically used for small portable electronic devices, such as mobile phones, notebook computers, camcorders, and the like, while a large-capacity rechargeable battery may be used as a motor-driving power source for a hybrid vehicles, or an electric vehicle for example.

The rechargeable battery may be used in small electronic devices as a single-cell battery or as a motor-driving power source, for example, as a battery module in which a plurality of cells are electrically connected. The rechargeable battery module may be formed by connecting electrode terminals through a bus bar.

In the rechargeable battery module, neighboring unit cells are electrically connected, and an insulating layer may be formed for external insulation of each unit cell. However, portions where the insulating layer is not provided may be electrically connected through water. That is, an aqueous circuit may cause an external short circuit of the unit cell.

The above information disclosed in this Background section is only for enhancement of understanding of the background of the described technology and therefore it may contain information that does not form the prior art that is already known in this country to a person of ordinary skill in the art.

### SUMMARY

According to an aspect of embodiments of the present invention, a rechargeable battery and a module thereof are configured for preventing or substantially preventing an external short circuit caused by an aqueous circuit. According to another aspect of embodiments of the present invention, a rechargeable battery and a module thereof have improved external insulation properties.

According to an exemplary embodiment of the present invention, a rechargeable battery includes: a unit cell including an electrode assembly, a case containing the electrode assembly, a cap plate covering an opening of the case, and a terminal electrically connected to the electrode assembly and protruding through the cap plate; and a cover including an electrically insulating material and covering the cap plate, the cover having an opening exposing the terminal therethrough.

The rechargeable battery may further include an insulation member receiving the unit cell, and the cover may cover the insulation member.

The insulation member may include an edge portion and an opening in the edge portion, and the edge portion may partially cover a first surface of the unit cell. The insulation member may be expandable to receive the unit cell through the opening in the edge portion. The rechargeable battery may further include a cell seal between the edge portion and the cover.

At least one of the edge portion or the cover may be attached to the unit cell via an adhesive,

The cover may be coupled to a portion of the unit cell.

The rechargeable battery may further include a cell seal between the cap plate and the cover.

The rechargeable battery may further include a terminal seal surrounding the terminal and being arranged between the cover and the cap plate.

The terminal may include a first terminal and a second terminal, the unit cell may further include an insulator between the cap plate and the first terminal, and a connection plate between the cap plate and the second terminal, and the opening of the cover may include a first opening exposing the first terminal and connected with the insulator, and a second opening exposing the second terminal and connected with the connection plate.

The cover may have a drain groove extending to a side of the cover.

The cover may include a first portion extending from a surface of the cover toward the unit cell, the first portion being coupled to the unit cell.

According to another exemplary embodiment of the present invention, a battery module includes: a plurality of unit cells, each including an electrode assembly, a case containing the electrode assembly, a cap plate covering an opening of the case, and a terminal electrically connected to the electrode assembly and protruding through the cap plate; and a cover including an electrically insulating material and covering the unit cells, the cover having at least one opening exposing the terminals therethrough.

The battery module may further include an insulation member receiving the unit cells, and the cover may cover the insulation member.

The insulation member may include an integral insulation member including a cell barrier separating adjacent unit cells of the plurality of unit cells.

The battery module may further include a plurality of cell seals between the insulation member and the cover, each of the cell seals being arranged around a periphery of a first surface of a corresponding unit cell of the plurality of unit cells.

The cover may include an integral cover member covering the plurality of unit cells.

The battery module may further include a plurality of terminal seals, each surrounding the terminal of a corresponding unit cell of the plurality of unit cells and being arranged between the cover and the cap plate of the corresponding unit cell. The battery module may further include a plurality of cell seals, each between the cover and the cap plate of a respective unit cell of the corresponding unit cells, each of the cell seals being arranged around a periphery of the cap plate of the respective unit cell and surrounding the terminal of the respective unit cell.

The cover may have a drain groove extending to a side of the cover,

A rechargeable battery module according to an exemplary embodiment includes unit cells each forming rechargeable battery, an insulation member for receiving the unit cells, and a cover for covering the unit cells.

A rechargeable battery according to an exemplary embodiment includes an electrode assembly for charging and discharging currents, a case for containing the electrode assembly, a cap plate connected with an opening of the case, an electrode terminal attached to a terminal hole of the cap plate, an insulation member for receiving the case, and a cover for covering the cap plate.

According to an exemplary embodiment, the unit cell can be received by the insulation member and covered with the cover, thus preventing or substantially preventing an external short circuit caused by an aqueous circuit.

### BRIEF DESCRIPTION OF THE DRAWINGS

The accompanying drawings, together with the specification, illustrate some exemplary embodiments of the present invention, and, together with the description, serve to explain principles and aspects of the present invention.

FIG. 1 is a perspective view of a rechargeable battery module according to an exemplary embodiment of the present invention.

FIG. 2 is an exploded perspective view of the rechargeable battery module of FIG. 1.

FIG. 3 is an exploded perspective view of a rechargeable battery according to an exemplary embodiment of the present invention.

FIG. 4 is a cross-sectional view of the rechargeable battery of FIG. 3, taken along the line IV-IV.

FIG. 5 is a cross-sectional view of the rechargeable battery module of FIG. 1, taken along the line V-V.

FIG. 6 is an exploded perspective view of a rechargeable battery according to another exemplary embodiment of the present invention.

FIG. 7 is an exploded perspective view of a rechargeable battery according to another exemplary embodiment of the present invention.

FIG. 8 is an exploded perspective view of a rechargeable battery module according to another exemplary embodiment of the present invention.

Description of Reference Numerals Indicating
Some Elements In the Drawings

| | |
|---|---|
| 10: electrode assembly | 11: first electrode |
| 11a, 12a: coated region | 11b, 12b: uncoated region |
| 12: second electrode | 13: separator |
| 15: case | 20: cap plate |
| 21: first electrode terminal | 21a, 22a: rivet terminal |
| 21b, 22b: flange | 21c, 22c: plate terminal |
| 22: second electrode terminal | 24: vent hole |
| 25: vent plate | 25a: notch |
| 27: sealing plug | 29: electrolyte injection opening |

36, 37: first and second electrode gaskets

| | |
|---|---|
| 45: insulator | 46: top plate |

51, 52: first and second electrode lead tabs
61, 62: first and second electrode insulation members

| | |
|---|---|
| 100: unit ceils | 200: insulation member |
| 201: cell barrier | 202: opening |
| 203: upper edge | 300: cover |
| 301, 302: first and second openings | 303, 304: first and second drain |
| | grooves |
| 400: cell sealing | 500: terminal sealing |
| H1, H2: terminal hole | |

### DETAILED DESCRIPTION

In the following detailed description, certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

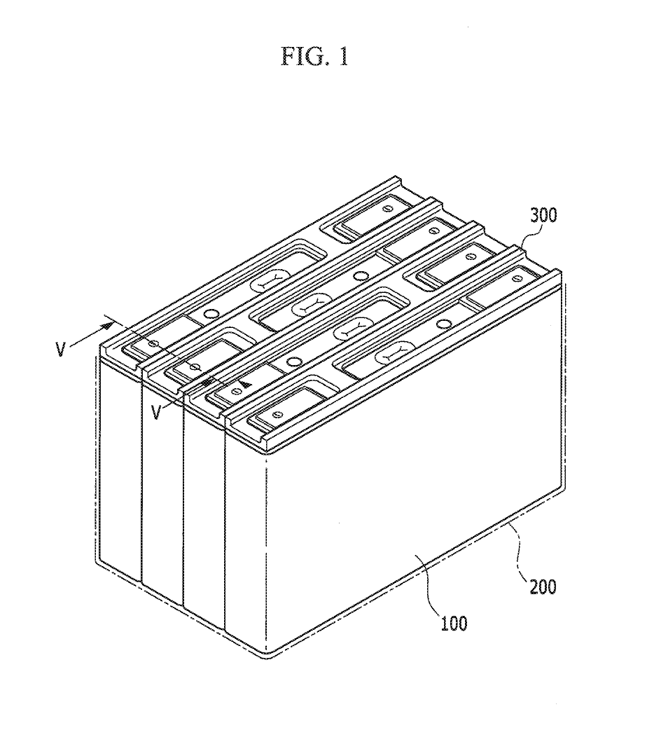

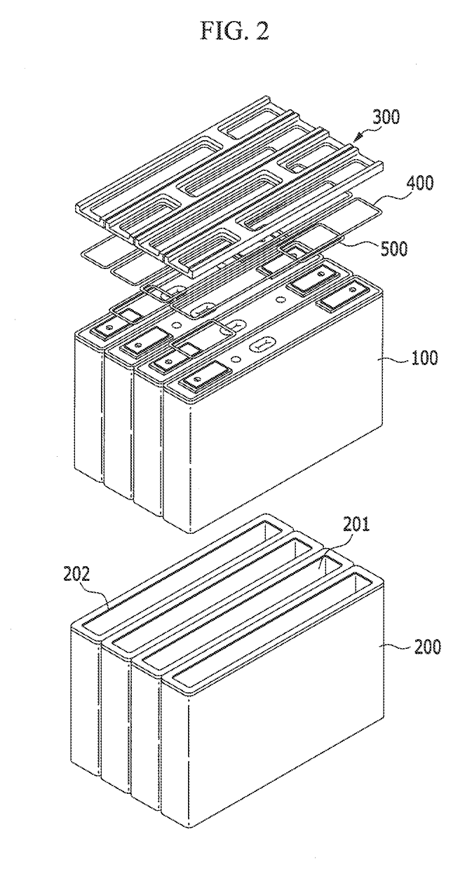

FIG. 1 is a perspective view of a rechargeable battery module according to an exemplary embodiment of the present invention, and FIG. 2 is an exploded perspective view of the rechargeable battery module of FIG. 1.

Referring to FIGS. 1 and 2, a rechargeable battery module according to an embodiment of the present invention includes unit cells 100 each forming a rechargeable battery, an insulation member 200 for receiving the unit cells 100, and a cover 300 for covering the unit cells 100.

The insulation member 200 and the cover 300 are used for external insulation of the unit cells 100, and may prevent or substantially prevent an external short circuit of the unit cells 100 due to an aqueous circuit formed by condensed water. That is, in one embodiment, the insulation member 200 and cover 300 have structures for individually insulating the unit cells 100.

In one embodiment, as shown in FIG. 2, the insulation member 200 may have a one-body structure in which each of the unit cells 100 is independently received and insulated. In this case, the cover 300 may individually cover the unit cells 100 while in contact with the insulation member 200.

The insulation member 200 may be formed in a one-body structure in which the unit cells 100 are independently received or in an individual structure in which the unit cells 100 are independently insulated. In either of the two cases, the cover 300 may alternatively be formed in a one-body structure (not shown) in which a plurality of the unit cells 100 is insulated.

As shown in FIGS. 1 and 2, the insulation member 200, in one embodiment, is formed as one body and has receiving spaces which are separated by cell barriers 201, and may be formed in a flexible housing structure.

Accordingly, openings 202 formed on the insulation member 200 may be expanded and then contracted when the unit cells 100 are inserted, thus enabling the unit cells 100 to be held.

In one embodiment, the rechargeable battery module may further include cell sealings 400 between the insulation member 200 and the cover 300. The cell sealings 400 are disposed around the unit cells 100, respectively, so that the unit cells 100 may be sealed individually.

In one embodiment, one insulation member 200 and one cover 300 are provided to one unit cell 100. In this case, one cell sealing 400 seals the insulation member 200 for receiving the unit cell 100 from the cover 300 for covering the unit cell 100. Accordingly, an external short circuit between neighboring unit cells 100 is prevented or substantially prevented.

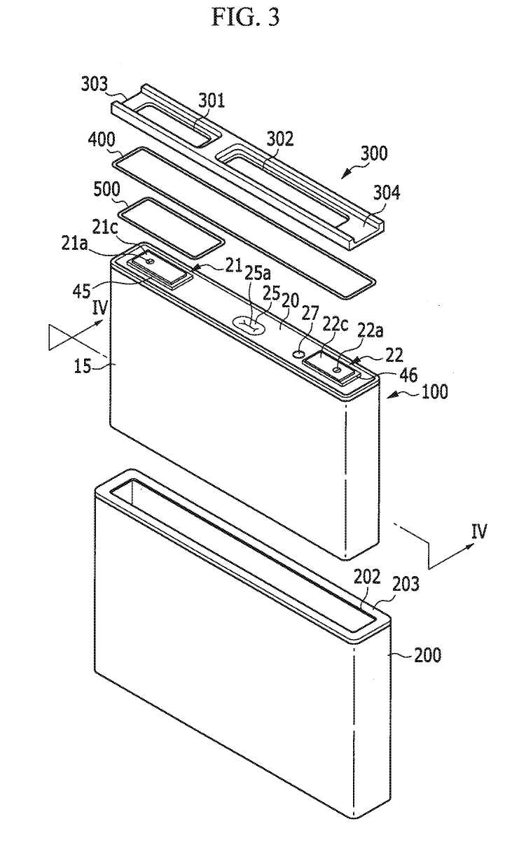

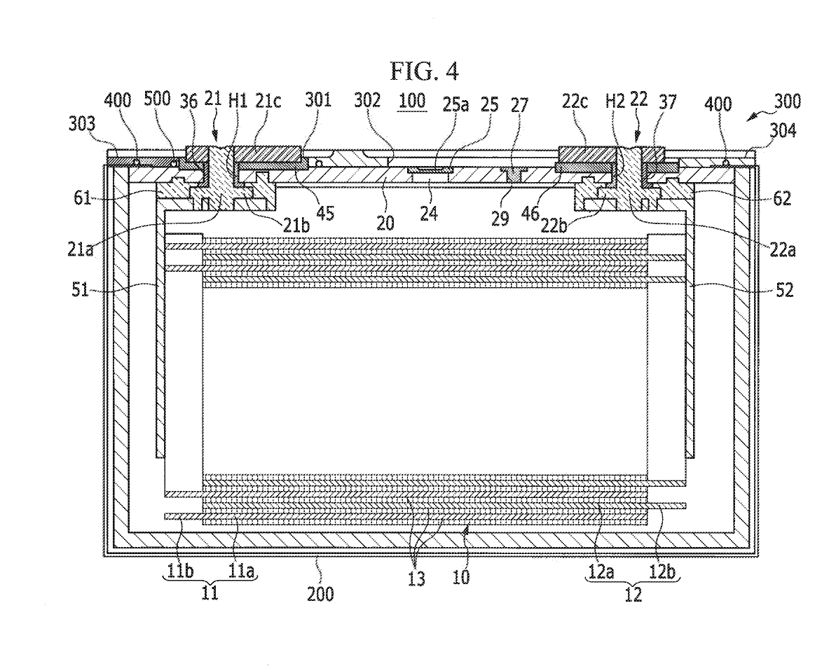

FIG. 3 is an exploded perspective view of a rechargeable battery according to an exemplary embodiment of the present invention, and FIG. 4 is a cross-sectional view of the rechargeable battery of FIG. 3, taken along the line IV-IV,

Referring to FIGS. 3 and 4, the unit cell 100 includes an electrode assembly 10 for charging and discharging currents, a case 15 for containing the electrode assembly 10, a cap plate 20 sealing an opening of the case 15, and a first electrode terminal 21 (e.g., a negative terminal) and a second electrode terminal 22 (e.g., a positive terminal) attached to the cap plate 20,

As in the rechargeable battery module described above, the unit cell 100 includes an insulation member 200 for receiving the unit cell 100, and a cover 300 for covering the unit cell 100. In one embodiment, the unit cell 100 may further include a cell sealing 400 provided between the insulation member 200 and the cover 300,

The electrode assembly 10 may be formed by disposing a first electrode 11 (e.g., a negative electrode) and a second electrode 12 (e.g., a positive electrode) at both sides of a separator 13, which is an insulator, and winding the first electrode 11, the separator 13, and the second electrode 12 in a jelly roll shape.

The first electrode 11 and the second electrode 12 include coated regions 11a and 12a and uncoated regions 11b and 12b, respectively. The coated regions 11a and 12a are formed by applying an active material to a current collector of a metal plate, and the uncoated regions 11b and 12b are formed as an exposed current collector where the active material is not applied.

In one embodiment, the uncoated region 11b of the first electrode 11 is formed at one end of the first electrode 11 along the first electrode 11, which is wound, the uncoated region 12b of the second electrode 12 is formed at one end of the second electrode 12 along the second electrode 12, which is wound, and the uncoated regions 11b and 12b are disposed at respective ends of the electrode assembly 10.

In one embodiment, the case 15 has an approximately cuboid shape, an inner space for receiving the electrode assembly 10 and electrolyte solution, and an opening formed at one side of the case 15 for connecting the inner space with the outside. The opening allows the electrode assembly 10 to be inserted into the case 15.

The cap plate 20 is attached to the case 15 at the opening to seal the case 15. In one embodiment, the case 15 and the cap plate 20 are formed of aluminum and are welded together.

In one embodiment, the cap plate 20 includes an electrolyte injection opening 29, a vent hole 24, and terminal holes H1 and H2. The electrolyte solution may be injected into the case 15 through the electrolyte injection opening 29 after the cap plate 20 is combined with the case 15. The electrolyte injection opening 29 may be sealed with a sealing plug 27 when the electrolyte solution is completely injected.

The vent hole 24 may be closed and sealed with a vent plate 25 so as to release an internal pressure of the rechargeable battery. The vent plate 25 is cut or ruptured to open the vent hole 24 when the internal pressure reaches or exceeds a pressure (e.g., a predetermined pressure). The vent plate 25 may have a notch 25a for guiding the cut.

The first terminal 21 and the second terminal 22 are connected through the terminal holes H1 and H2 of the cap plate 20 and electrically connected to the electrode assembly 10. That is, the first electrode 21 is electrically connected to the first electrode 11 of the electrode assembly 10, and the second terminal 22 is electrically connected to the second electrode 12 of the electrode assembly 10. Accordingly, the electrode assembly 10 is drawn out to an outside of the case 15 through the first terminal 21 and the second terminal 22.

In one embodiment, the first and second terminals 21 and 22 include rivet terminals 21a and 22a attached to the terminal holes H1 and H2 of the cap plate 20, flanges 21b and 22b formed integrally with the rivet terminals 21a and 22a inside the cap plate 20, and plate terminals 21c and 22c disposed outside the cap plate 20 and connected with the rivet terminals 21a and 22a, respectively, such as through riveting or welding.

First and second electrode gaskets 36 and 37 are attached between the rivet terminals 21a and 22a of the first and second terminals 21 and 22 and the terminal holes H1 and H2, respectively, of the cap plate 20, thus sealing and electrically insulating the cap plate 20 from the rivet terminals 21a and 22a of the first and second terminals 21 and 22, respectively.

The first and second electrode gaskets 36 and 37, in one embodiment, are extended and attached between the flanges 21b and 22b and an inner surface of the cap plate 20 to further seal and electrically insulate the flanges 21b and 22b, respectively, from the cap plate 20. The first and second electrode gaskets 36 and 37 prevent or substantially prevent leakage of the electrolyte solution through the terminal holes H1 and H2, respectively, which may otherwise be caused by attaching the first and second terminals 21 and 22 to the cap plate 20.

First and second electrode lead tabs 51 and 52 electrically connect the first and second terminals 21 and 22 to the first and second electrodes 11 and 12 of the electrode assembly 10, respectively. In one embodiment, the first and second electrode lead tabs 51 and 52 are connected to lower portions of the rivet terminals 21a and 22a to caulk the lower portions, respectively. Thus, in one embodiment, the first and second electrode lead tabs 51 and 52 are supported by the flange 21b and 22b and connected to the lower portions of the rivet terminals 21a and 22a, respectively.

In one embodiment, first and second electrode insulation members 61 and 62 are attached between the first and second electrode lead tabs 51 and 52 and the cap plate 20 to electrically insulate the first and second electrode lead tabs 51 and 52, respectively, from the cap plate.

In one embodiment, the first and second electrode insulation members 61 and 62 each have one side connected to the cap plate 20 and other sides surrounding the first and second electrode lead tabs 51 and 52, the rivet terminals 21a and 22a, and the flanges 21b and 22b, respectively, thus stabilizing connection structures thereof.

In one embodiment, an insulator 45 of the first terminal 21 is disposed between the cap plate 20 and the plate terminal 21c of the first terminal 21 and passes through the rivet terminal 21a to electrically insulate the plate terminal 21c from the cap plate 20.

The cap plate 20, in one embodiment, has a receiving groove formed on an outer surface thereof and receives a lower portion of the insulator 45, such that the insulator 45 and the first terminal 21 may be accurately located on the cap plate 20.

In one embodiment, the insulator 45 and the plate terminal 21c are connected to an upper portion of the rivet terminal 21a to caulk the upper portion of the rivet terminal 21a. Thus, in one embodiment, the insulator 45 and the plate terminal 21c are coupled to the upper portion of the rivet terminal 21a, such that the plate terminal 21c is attached outside the cap plate 20, and the insulator 45 is disposed therebetween.

The first electrode gasket 36, in one embodiment, is extended between the rivet terminal 21a and the insulator 45 through the terminal hole H1. That is, in one embodiment, the first electrode gasket 36 electrically insulates the rivet terminal 21a from the cap plate 20.

In one embodiment, a top plate 46 of the second terminal 22 is disposed between the plate terminal 22c and the cap plate 20 and passes through the rivet terminal 22a to electrically connect the plate terminal 22c with the cap plate 20.

The cap plate 20, in one embodiment, may have a receiving groove formed on the outer surface thereof and receiving a lower portion of the top plate 46, such that the top plate 46 and the second terminal 22 may be accurately located on the cap plate 20.

In one embodiment, the top plate 46 and the plate terminal 22c are connected to an upper portion of the rivet terminal 22a to caulk the upper portion of the rivet terminal 22a. Thus, in one embodiment, the top plate 46 and the plate terminal 22c are coupled to the upper portion of the rivet terminal 22a, and the plate terminal 22c is attached outside the cap plate 20 while the top plate 46 is disposed therebetween.

The second electrode gasket 37, in one embodiment, is extended between the rivet terminal 22a and the top plate 46 through the terminal hole H2. That is, the second electrode gasket 37 prevents or substantially prevents the rivet terminal 22a and the top plate 46 from being electrically and directly connected, and the rivet terminal 22a is electrically connected to the top plate 46 through the plate terminal 22c.

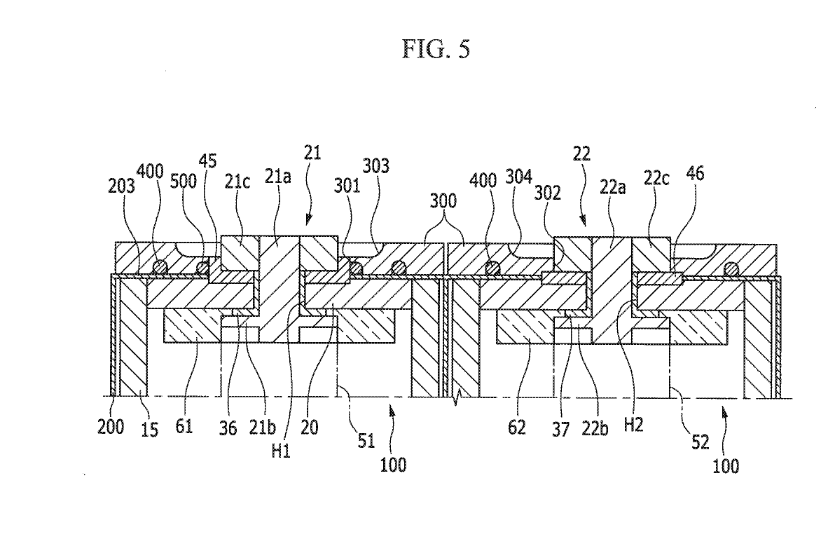

FIG. 5 is a cross-sectional view of the rechargeable battery module of FIG. 1, taken along the line V-V. Referring to FIGS. 3 to 5, in one embodiment, the unit cell 100 may further include a terminal sealing 500 between the insulation member 200 and the cover 300. The terminal sealing 500 is provided to seal the first terminal 21 or the second terminal 22 in the unit cell 100, thus preventing or substantially preventing an external short circuit caused by an aqueous circuit.

In one embodiment, in the unit cell 100, the terminal sealing 500 is disposed around at least one of the first and second terminals 21 and 22 to seal the terminal. For convenience, FIG. 5 illustrates a configuration in which the terminal sealing 500 is disposed outside the first terminal 21.

The cap plate 20 of the unit cell 100 is disposed at the opening 202 of the insulation member 200, and an upper edge 203 forming the opening 202 of the insulation member 200 is disposed on the cap plate 20. That is, the upper edge 203 of the insulation member 200 is disposed between the cap plate 20 and the cover 300 to insulate therebetween.

The cell sealing 400, in one embodiment, is disposed between the cap plate 20 and the cover 300. The cell sealing 400 may be disposed between the cover 300 and the upper edge 203 of the insulation member 200 disposed on the cap plate 20 to block an aqueous circuit that may be formed from outside the unit cell 100 to inside the unit cell 100.

The terminal sealing 500, in one embodiment, is disposed between the cap plate 20 and the cover 300. The terminal sealing 500 may be disposed outside the insulator 45 to block an aqueous circuit that may be formed from the first terminal 21 to the second terminal 22 in the unit cell 100.

In one embodiment, the first terminal 21 has a dual sealing structure formed with the cell sealing 400 and the terminal sealing 500, and the second terminal 22 has a single sealing structure formed with the cell sealing 400. Accordingly, in the first terminal 21 and the second terminal 22 of neighboring unit cells 100, an aqueous circuit is blocked by one terminal sealing 500 and two cell sealings 400.

The cover 300 is made of an electrically insulating material and covers the cap plate 20. The cover 300, in one embodiment, has receiving grooves for connecting the cell sealing 400 and the terminal sealing 500 to fix the cell sealing 400 and the terminal sealing 500 to positions thereof on the cap plate 20. The cover 300, in one embodiment, has a first opening 301 for exposing the first terminal 21 and a second opening 302 for exposing the second terminal 22. The second opening 302 may be formed to further expose the vent hole 24 and the electrolyte injection opening 29.

The first opening 301 is connected with the insulator 45 of the first terminal 21, and the second opening 302 is connected with the top plate 46 of the second terminal 22. Accordingly, the cover 300 may be accurately located on the cap plate 20.

The cover 300, in one embodiment, has a first drain groove 303 and a second drain groove 304 formed along or surrounding the first opening 301 and the second opening 302, respectively, to drain condensed water. The first drain groove 303 may be formed at a side of the first opening 301 to guide water to one side of the insulation member 200. The second drain groove 304 may be formed at an opposite side of the first drain groove 303 in the second opening 302 to guide water to another side of the insulation member 200.

In one embodiment, the first and second drain grooves 303 and 304 are formed in a curved surface toward the first and second terminals 21 and 22, respectively, to facilitate collecting condensed water. The first and second drain grooves 303 and 304, in one embodiment, are open at both sides in a lengthwise direction of the cap plate 20 to guide condensed water to both sides of the unit cell 100 and drain the condensed water to side surfaces of the insulation member 200.

The rechargeable battery module may be formed by disposing a bus bar (not shown) on the cover 300 and welding both ends of the bus bar with the plate terminals 21c and 22c of the first and second terminals 21 and 22, respectively. The cell sealing 400 and the terminal sealing 500 may maintain the aqueous circuit being strongly blocked by a weld strength between the bus bar and the plate terminals 21c and 22c.

In one embodiment, the rechargeable battery may be formed by attaching cover 300 and the upper edge 203 of the insulation member 200 to the unit cell 100 with an adhesive (not shown). The cell sealing 400 and the terminal sealing 500 may maintain the aqueous circuit being strongly blocked by adherence of the adhesive.

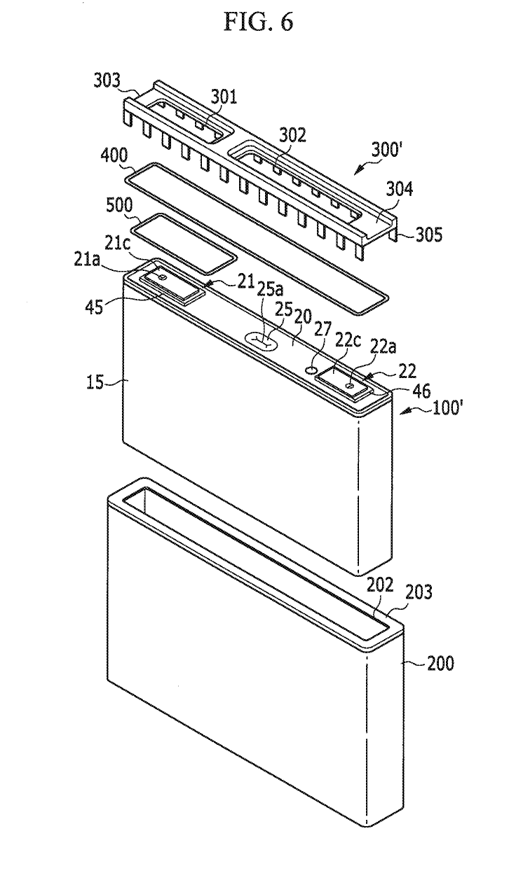

FIG. 6 is an exploded perspective view of a rechargeable battery according to another exemplary embodiment of the present invention.

Referring to FIG. 6, a unit cell 100′ forming a rechargeable battery according to another embodiment of the present invention includes the electrode assembly 10, the case 15 for containing the electrode assembly 10, the cap plate 20 sealing an opening of the case 15, and the first electrode terminal 21 (e.g., a negative terminal) and the second electrode terminal 22 (e.g., a positive terminal) attached to the cap plate 20. As in the unit cell 100 described above, the unit cell 100′ includes the insulation member 200 for receiving the unit cell 100′, and a cover 300′ for covering the unit cell 100′. In one embodiment, the unit cell 100′ may further include the cell sealing 400 and the terminal sealing 500 provided between the insulation member 200 and the cover 300′. Like the cover 300 described above, the cover 300′, in one embodiment, includes the first and second openings 301 and 302, and the first and second drain grooves 303 and 304. The cover 300′ differs from the cover 300 described above in that the cover 300′ further includes a plurality of extending portions 305 extending from each side of the cover 300′ along a lengthwise direction of the cover 300′. The extending portions 305 extend from a surface of the cover 300′ that is facing the cap plate 20 and are coupled to the unit cell 100′. In one embodiment, the extending portions 305 are coupled to lateral side surfaces of the insulation member 200.

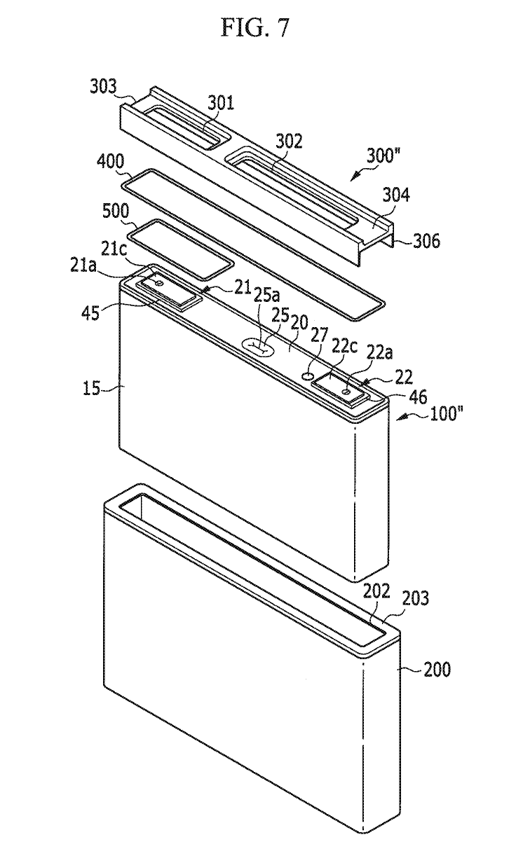

FIG. 7 is an exploded perspective view of a rechargeable battery according to another exemplary embodiment of the present invention.

Referring to FIG. 7, a unit cell 100″ forming a rechargeable battery according to another embodiment of the present invention is substantially similar to the unit cell 100′ described above and shown in FIG. 6. The unit cell 100″, however, includes a cover 300″ that differs from the cover 300′ described above in that the cover 300″ includes a single continuous extending portion 306 extending from each side of the cover 300″ along a lengthwise direction of the cover 300″. The extending portions 306 extend from a surface of the cover 300″ that is facing the cap plate 20 and are coupled to the unit cell 100″. In one embodiment, the extending portions 306 are coupled to lateral side surfaces of the insulation member 200.

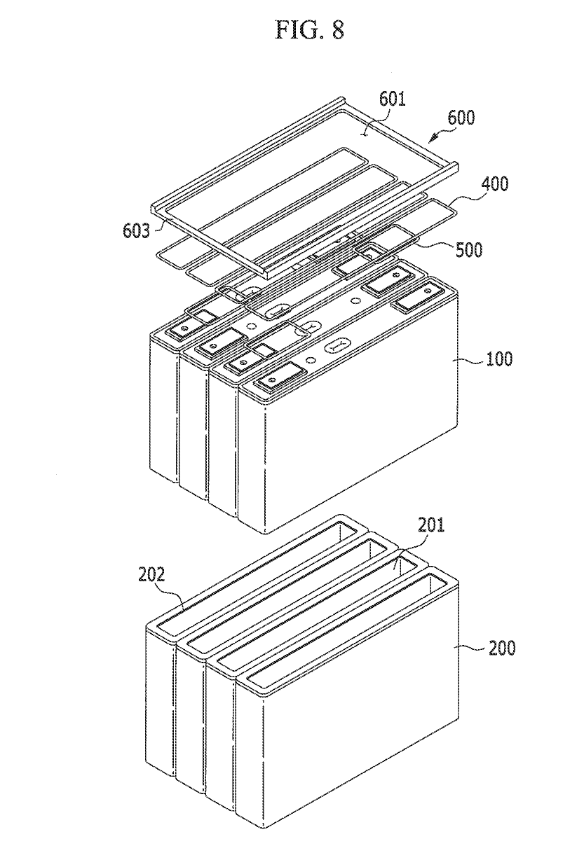

FIG. 8 is an exploded perspective view of a rechargeable battery module according to another exemplary embodiment of the present invention.

Referring to FIG. 8, a rechargeable battery module according to another embodiment of the present invention includes unit cells 100 each forming a rechargeable battery, the insulation member 200 for receiving the unit cells 100, and a cover 600 for covering the unit cells 100. The cover 600 is formed in a one-body structure in which a plurality of the unit cells 100 is insulated. The cover 600, in one embodiment, has an opening 601 for exposing the first terminals 21 and the second terminals 22 of the plurality of unit cells 100, and a drain groove 603 formed along or surrounding the opening 601 to drain condensed water. The rechargeable battery may further include the cell sealings 400 and the terminal sealings 500 between the insulation member 200 and the cover 600.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A rechargeable battery comprising:
a unit cell comprising:
an electrode assembly;
a case containing the electrode assembly;
a cap plate covering an opening of the case; and
a terminal electrically connected to the electrode assembly and protruding through the cap plate; and
a cover comprising an electrically insulating material and covering the cap plate,
wherein the cover has an opening exposing the terminal therethrough.

2. The rechargeable battery of claim 1, further comprising an insulation member receiving the unit cell, wherein the cover covers the insulation member.

3. The rechargeable battery of claim 2,
wherein the insulation member comprises an edge portion and an opening in the edge portion, and
wherein the edge portion partially covers a first surface of the unit cell.

4. The rechargeable battery of claim 3, wherein the insulation member is expandable to receive the unit cell through the opening in the edge portion.

5. The rechargeable battery of claim 3, further comprising a cell seal between the edge portion and the cover.

6. The rechargeable battery of claim 3, wherein at least one of the edge portion or the cover is attached to the unit cell via an adhesive.

7. The rechargeable battery of claim 1, wherein the cover is coupled to a portion of the unit cell.

8. The rechargeable battery of claim 1, further comprising a cell seal between the cap plate and the cover.

9. The rechargeable battery of claim 1, further comprising a terminal seal surrounding the terminal and being arranged between the cover and the cap plate.

10. The rechargeable battery of claim 1,
wherein the terminal includes a first terminal and a second terminal,
wherein the unit cell further comprises an insulator between the cap plate and the first terminal, and a connection plate between the cap plate and the second terminal, and
wherein the opening of the cover includes a first opening exposing the first terminal and connected with the insulator, and a second opening exposing the second terminal and connected with the connection plate.

11. The rechargeable battery of claim 1, wherein the cover has a drain groove extending to a side of the cover.

12. The rechargeable battery of claim 1, wherein the cover comprises a first portion extending from a surface of the cover toward the unit cell, the first portion being coupled to the unit cell.

13. A battery module comprising:
a plurality of unit cells, each comprising:
an electrode assembly;
a case containing the electrode assembly;
a cap plate covering an opening of the case; and
a terminal electrically connected to the electrode assembly and protruding through the cap plate; and
a cover comprising an electrically insulating material and covering the unit cells,
wherein the cover has at least one opening exposing the terminals therethrough.

14. The battery module of claim 13, further comprising an insulation member receiving the unit cells, wherein the cover covers the insulation member.

15. The battery module of claim 14, wherein the insulation member comprises an integral insulation member comprising a cell barrier separating adjacent unit cells of the plurality of unit cells.

16. The battery module of claim 14, further comprising a plurality of cell seals between the insulation member and the cover, each of the cell seals being arranged around a periphery of a first surface of a corresponding unit cell of the plurality of unit cells.

17. The battery module of claim 13, wherein the cover comprises an integral cover member covering the plurality of unit cells.

18. The battery module of claim 13, further comprising a plurality of terminal seals, each surrounding the terminal of a corresponding unit cell of the plurality of unit cells and being arranged between the cover and the cap plate of the corresponding unit cell.

19. The battery module of claim 18, further comprising a plurality of cell seals, each between the cover and the cap plate of a respective unit cell of the corresponding unit cells, each of the cell seals being arranged around a periphery of the cap plate of the respective unit cell and surrounding the terminal of the respective unit cell.

20. The battery module of claim 13, wherein the cover has a drain groove extending to a side of the cover.
